(19) United States
(12) Patent Application Publication
(10) Pub. No.: US 2008/0111750 A1
(43) Pub. Date: May 15, 2008

(54) WAVE TRANSMITTING/RECEIVING STRUCTURE FOR VEHICLE ANTENNAS

(76) Inventor: Norio Yoshie, Toyota-shi (JP)

Correspondence Address: CHRISTIE, PARKER & HALE, LLP, PO BOX 7068, PASADENA, CA, 91109-7068, US

(21) Appl. No.: 11/764,139

(22) Filed: Jun. 15, 2007

(30) Foreign Application Priority Data
Nov. 7, 2006 (JP) 2006-301832

(51) Int. Cl. H01Q 1/32

(52) U.S. Cl. 343/713

(57) ABSTRACT

A vehicle antenna transmitting/receiving structure is provided, which is not affected by electric current that flows through the windshield. The vehicle antenna transmitting/receiving structure comprises a resin roof constituting at least a portion of the vehicle roof inclusive of a front end portion of the vehicle roof, and an overhead console for installing at least one or more antennas corresponding to electronic equipment of various information systems, the overhead console being installed inside the vehicle just under the resin roof.

BACKGROUND OF THE INVENTION

1 Field of the Invention

The present invention relates to a wave transmitting/receiving structure for vehicle antennas.

2. Description of Related Art

Vehicle antennas, such as an antenna for a vehicle radio or an antenna for GPS, have been made by utilizing a vehicle's frame structure, or have been separately installed in a dedicated GPS unit.

The related art of an antenna utilizing a vehicle's frame structure can be represented by an antenna which utilizes a loop structure of a metal frame and an antenna which is printed on glass. The former antenna can be seen in Japanese Unexamined Patent Publication (Kokai) No. 2003-249812 and the latter antenna can be seen in Japanese Unexamined National Publication (Kohyo) No. 2002-517114.

In Japanese Unexamined Patent Publication (Kokai) No. 11-208377, an overhead console is shown installed in one place with antennas corresponding to electronic equipment of various information systems. Although an overhead console has been provided in a ceiling portion of a vehicle between the driver's seat and the passenger's seat for accommodating small articles such as a pair of eyeglasses, such as in JUPP No. 11-208377, the overhead console is constituted by installed in one place room lamps and various antennas, such as a GPS antenna, an antenna for receiving road traffic information, a transmitting/receiving antenna for a road ETC system, a keyless entry signal receiving antenna, a garage opener antenna and an antenna for wireless communication.

However, because the overhead console of JUPP No. 11-208377 is placed very close to an upper end portion of the windshield of the vehicle, there exists a problem in that signals are adversely affected by electric current that flows through the windshield.

That is, when electric wiring is arranged in the windshield to function as a sun visor or for melting snow by passing an electric current through the windshield as disclosed in Japanese Unexamined Patent Publication (Kokai) No. 02-117413 and Japanese Unexamined Patent Publication (Kokai) No. 07-017364, noise can occur in the waves, which the antennas transmit and receive through the windshield.

### SUMMARY OF THE INVENTION

It is an object of the invention to provide a wave transmitting/receiving structure for vehicle antennas of electric equipment of various information systems together with the integral arrangement of antennas in one place in order to ensure transmitting/receiving performance not affected by electric current that flows through the windshield.

In accordance with the present invention, there is provided a wave transmitting/receiving structure for vehicle antennas receiving waves from the exterior of the vehicle and transmitting waves to the exterior of the vehicle, wherein the vehicle comprises a resin roof constituting at least a portion of the vehicle roof including the front end portion of the roof, and an overhead console disposed of at least one or more antennas for electric equipment of various information systems, the overhead console being installed inside the vehicle just under the resin roof.

That is, in the present invention, at least a portion of the vehicle roof inclusive of the front end portion of the roof is formed of resin, and an overhead console arranged with various antennas installed just under the resin roof. Since the waves arrive at the antennas by not passing through the windshield, but through the resin roof, the receiving waves are not affected by electric current. Also, because the waves are not transmitted through the windshield, but passed through the resin roof, the transmitting waves are not affected by electric current. Therefore, transmitting/receiving performance is not affected by electric current.

At least one or more antennas corresponding to the above-mentioned electric equipment of various information systems include a garage opener antenna, a GPS antenna, an ETC transmitting/receiving antenna, an inter-vehicle communication antenna, an antenna for receiving road traffic information, a keyless entry receiving antenna, a radio antenna, a TV antenna, etc..

According to the present invention, there exists an effect that the antennas of electric equipment of various information systems are arranged in one place, and that the transmitting/receiving performance of the antennas is not affected by electric current that flows through the windshield.

### BRIEF DESCRIPTION OF THE DRAWINGS

The present invention will be more clearly understood from the description as set below with reference to the accompanying drawings, wherein:

FIG. 1 is a schematically illustrated cross-sectional view of the constitution of an embodiment in accordance with the invention applied to a passenger car.

FIG. 2 is a schematically illustrated perspective view of the constitution of the embodiment in accordance with the invention shown for a whole passenger car.

FIG. 3 is a schematically illustrated perspective view of the constitution of another embodiment in accordance with the invention shown for a whole passenger car.

FIG. 4 is a schematically illustrated perspective view of a whole passenger car having a traditional roof structure shown for comparison in FIGS. 2 and 3.

FIG. 5 is a schematically illustrated perspective view of the constitution of the embodiment in accordance with the invention shown for an overhead console as seen from the interior of the vehicle.

FIG. 6 is a schematically illustrated perspective view of the constitution of the embodiment in accordance with the invention shown for the overhead console as seen from the roof side.

### DESCRIPTION OF THE PREFERRED EMBODIMENT

The embodiments of the invention will now be described with reference to the accompanying drawings.

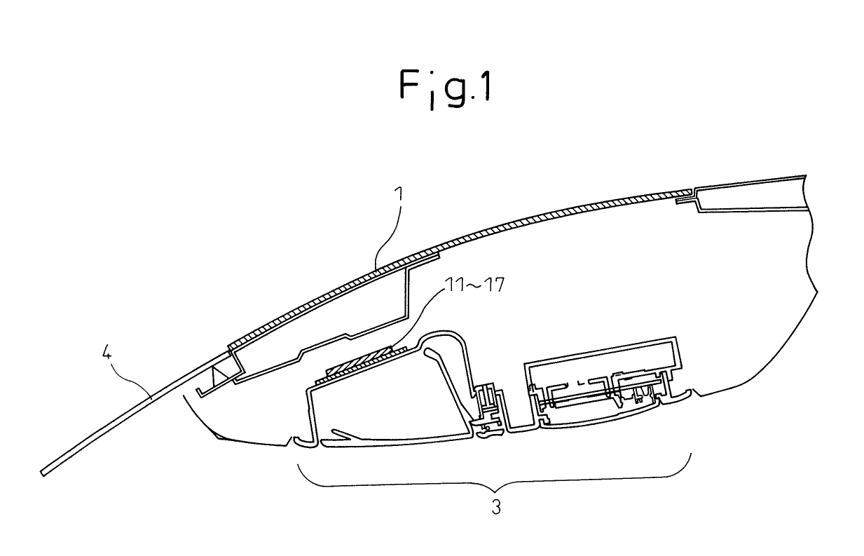

FIG. 1 shows the constitution of an embodiment of the invention when the invention is applied to a passenger car. At least a portion of the roof inclusive of the front end portion of the roof of an automobile is formed of a resin roof 1, and an overhead console 3 arranged with various antennas therein is installed just under the resin roof. Since waves arrive at the antennas by not passing through the windshield 4, but pass through the resin roof 1, the receiving waves are not affected by electric current. Also, since the waves are transmitted by not passing through the windshield 4, but pass through the resin roof 1, the transmitting waves are not affected by electric current. Therefore, transmitting/receiving performance is not affected by electric current.

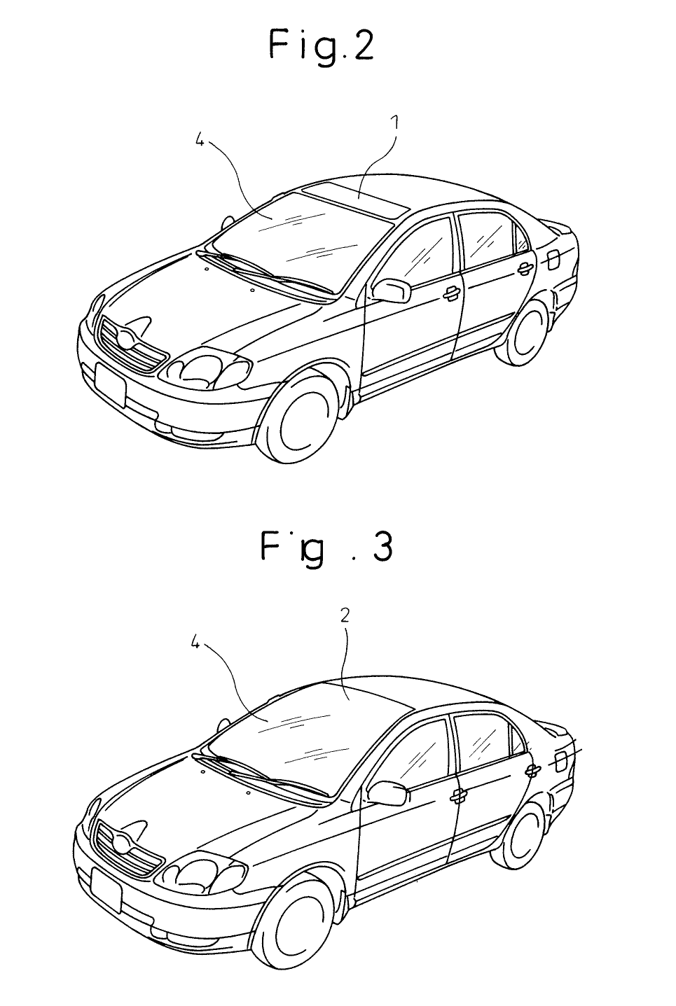

FIG. 2 shows a whole passenger car illustrating the constitution of an embodiment of the invention when the invention is applied to a passenger car. At least a portion of the roof inclusive of the front end portion of the roof of an automobile is formed of a resin roof 1, and waves are transmitted and received through the resin roof 1.

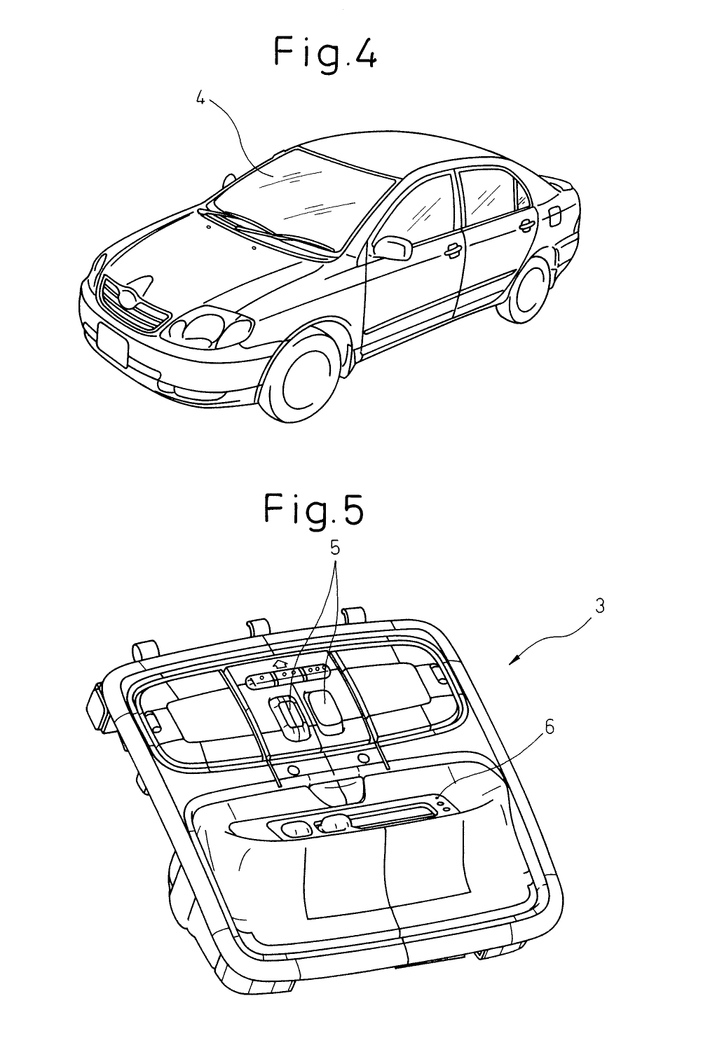

FIG. 3 shows the constitution of the invention when another embodiment of the invention is applied to a passenger car. The upper portion of the windshield 4 is extended up to a portion corresponding to the front end portion of the roof to thereby form an extended portion 2 of the roof. The function of a sun visor and of melting snow are installed in only the portion 4 corresponding to a traditional windshield (see FIG. 4); i.e., no electric wiring is arranged in the extended portion 2 of the windshield forming the front end portion of the roof, and therefore, no electric current flows therethrough. Therefore, waves are transmitted and received through the extended portion 2 of the windshield, and transmitting/receiving performance is not affected by electric current.

FIG. 4 shows a whole passenger car having a traditional roof structure for comparison in FIGS. 2 and 3.

FIG. 5 shows the constitution of the embodiment of the invention applied to the overhead console as seen from the interior of the vehicle. The overhead console 3 is equipped with a room illumination device 5, and controls the illumination in the vehicle compartment. The overhead console 3 further includes an ETC operation device and a card-holding portion 6 which may execute ETC control and display the fee of the ETC.

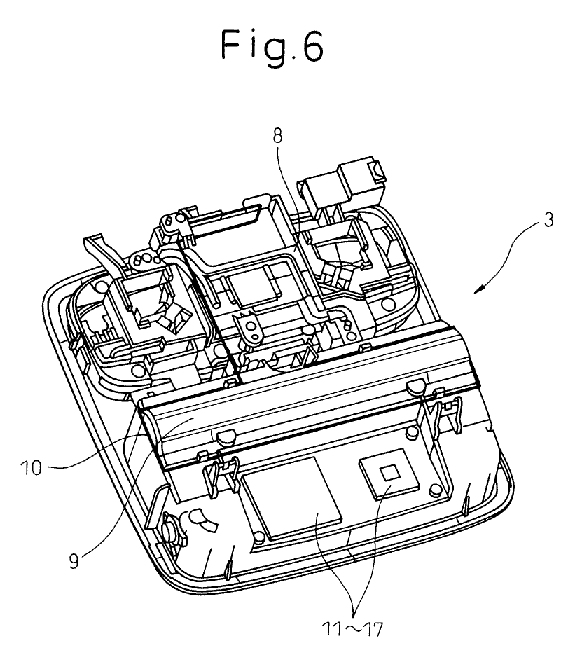

FIG. 6 shows the constitution of the embodiment of the invention applied to the overhead console as seen from the roof. The overhead console 3 can incorporate various antennas, such as a garage opener antenna 10, a GPS antenna 11, an ETC transmitting/receiving antenna 12, an inter-vehicle communication antenna 13, an antenna for receiving road traffic information 14, a keyless entry receiving antenna 15, a radio antenna 16 and a TV antenna 17. A room illumination device 5, an ETC operation device, a garage opener antenna 10, and various antennas 11 to 17 incorporated in the overhead console 3 are controlled by a control board 8, which can be arranged in a single substrate. In FIG. 6, the back surface 9 of a eyeglass holding portion is shown, which is treated with metal plating in order to protect the electric circuit from noise in the compartment and to ensure the performance of the antenna. Further, by a system circuit in the control board 8, the directivity of the antenna can be controlled, for example, the directivity of the antenna is directed toward the front of the vehicle for the ETC transmitting/receiving waves, while the antenna is rendered to be non-directional for the inter-vehicle communication so that waves can be transmitted and received in all directions.

Further, in accordance with another embodiment, the above various antennas may not be incorporated in the overhead console 3, but in a lamp assembly or in an integrated switch assembly in the vehicle.

Further, in accordance with another embodiment, the above various antennas may be installed as an integrated antenna device for antennas only in the compartment just under the resin roof, instead of in the overhead console 3 or in the lamp assembly.

Further, some of the above antennas 11 to 17 may be common antennas in order to reduce the number of the elements, for example, using a single element for both the ETC and the inter-vehicle communication and arranging a plurality of such common or single elements.

Moreover, some elements such as the GPS antenna, inter-vehicle communication antenna, radio antenna and TV antenna, may be designed to cope with a wide range of frequencies, and not limited to particular frequencies.

While the invention has been described with reference to specific embodiments chosen for the purpose of illustration, it should be apparent that numerous modifications could be made thereto by those skilled in the art without departing from the basic concept and scope of the invention.

What is claimed is:

1. A wave transmitting/receiving structure for vehicle antennas receiving waves from the exterior of the vehicle and transmitting waves to the exterior of the vehicle, wherein said vehicle comprises:
a resin roof constituting at least a portion of the vehicle roof including a front end portion of the roof; and
an overhead console disposed of at least one or more antennas corresponding to electric equipment of various information systems;
said overhead console being installed inside the vehicle just under said resin roof.

2. The wave transmitting/receiving structure for vehicle antennas of claim 1, wherein a roof portion of the vehicle corresponding to said resin roof is constituted by extending an upper part of the windshield instead of forming said resin roof.
